(19) United States
(12) Patent Application Publication
(10) Pub. No.: US 2003/0095595 A1
(43) Pub. Date: May 22, 2003

(54) Method and apparatus for picture compression

(75) Inventors: Andreas Hutter, Munchen (DE); Klaus Illgner-Fehns, Munchen (DE); Robert Kutka, Geltendorf (DE)

Correspondence Address: Peter F. Corless, EDWARDS & ANGELL, LLP, P.O. Box 9169, Boston, MA, 02209, US

(73) Assignee: Infineon Technologies AG, Munchen (DE)

(21) Appl. No.: 10/300,541

(22) Filed: Nov. 20, 2002

(30) Foreign Application Priority Data
Nov. 20, 2001 (DE) 101 56 851.7

(51) Int. Cl. H04N 11/04

(52) U.S. Cl. 375/240.05

(57) ABSTRACT

To allow an individual picture (1) which comprises picture values (3) grouped together into blocks (2) to be quickly compressed with good picture quality, the picture values (3) are quantized block by block by a quantization factor, with the data volume represented by quantized picture values (3) dropping as the quantization factor rises. After the picture values (3) in a block (2) have been quantized, an actual data volume is determined which corresponds to that data volume represented by the last block (2) quantized which is related to the number of picture values (3) in the last block (2) quantized, and a target data volume is determined which corresponds to that volume of storage space which is available for the picture values (3) still to be quantized and which is related to the number of picture values (3) still to be quantized. If the actual data volume is larger than the target data volume the quantization factor is raised, and vice versa. The target data volume may also be multiplied by a reserve factor<1 before the comparison with the actual data volume to anticipate any unexpected demand for data.

The present invention relates to a method of picture compression such as can be used in, for example, video or TV encoding or decoding, and to a corresponding apparatus for picture compression.

Digital TV systems almost always call for the amount of data needed for the transmission of video information to be reduced or in other words compressed. The majority of applications of video compression methods require the amount of data to be held at a certain magnitude in this case after the compression. This magnitude is adjustable and is scaled to the picture quality given by the decoded signal. In most cases it is the quantization which is the adjusting parameter. To achieve a given target rate, rate control, i.e. regulation of the quantization, is necessary. In certain methods of data compression it is then a question of obtaining fast and lag-free rate control.

A method of compressing video data of this kind is used for example in the storage of reference pictures when changing the format of television signals, there being only a limited amount of memory space available for storing the reference picture. It can for example be made possible for television signals to be shown on small monitors by a compression method of this kind. A compression method of this kind can also be used for encoding for video recorders which have constant data segments for changeover points.

To allow a picture to be compressed to a fixed amount of data, it is possible for the statistics of the picture to be learnt from the preceding pictures in a sequence of pictures and the quantization for compressing the picture to be set accordingly, as is described in for example G.Keesman, I.Shah and R.Klein-Gunnewiek, “Bit-rate control for MPEG encoders”, Signal Processing: Image Communication (1995), Vol.6, No.6, pages 545-60. A method of this kind is not however suitable for compressing individual pictures.

It is an object of the present invention therefore to provide a method and an apparatus for picture compression by which an individual picture can be compressed quickly and with no advance analysis of the statistics and with good picture quality.

In accordance with the invention, the above object is achieved by a method having the features given in claim 1 and by an apparatus having the features given in claim 15. The subclaims each define preferred and advantageous embodiments of the present invention.

In accordance with the invention, it is proposed that the picture values of the picture to be compressed be divided into blocks and be quantized block by block by a quantization factor, with the data volume represented by quantized picture values dropping as the quantization factor rises. The quantization may in particular take the form of the division of a numerical value representing a picture value by the quantization factor, which means that with rising quantization factors the result of the quantization will become smaller and will thus comprise a smaller data volume, or in other words will be compressed.

In accordance with the invention, after the picture values in a block have been quantized, an actual data volume, which is an indication of the data volume represented by the quantized picture values in the last block quantized, is determined. The actual data volume is in particular that data volume represented by the quantized picture values in the last block quantized which is related to the number of picture values in said last block quantized. Also determined is a target data volume, which is an indication of the data volume which can still be assigned, in the total remaining data volume that is available, to the quantized picture values in a block of the same size as the block quantized previously, which means that at the end the total data volume represented by all the quantized picture values will not exceed the residual data volume available at the beginning, it being assumed that the quantization or rather compression of the picture values in the blocks still to be quantized will remain substantially the same. In this way it is determined whether the picture values in the last block quantized, as measured by their number compared with the total number of picture values in the block, will, after quantization, represent too large or too small a data volume. If the data volume represented by the picture values quantized previously is too large, the quantization factor is raised to give greater compression, and if the data volume represented by the picture values quantized previously is too small, the quantization factor is lowered to give less compression. In this way the quantization factor adjusts, in the course of the quantization, to an optimum value which allows the total data volume represented by the quantized picture values to be equal to a presettable value. If the actual data volume is equal to the target data volume, the quantization factor is preferably lowered, though it could also be raised or left unchanged in this case.

In this way it becomes possible to quantize a picture by a fast method, with the quantization being adjusted in such a way that the quantized picture values will fit into a memory of a defined volume.

The picture values are advantageously divided into blocks in such a way that each block contains the same number of picture values. When this is the case, the method can be simplified by making the actual data volume equal to the data volume represented by the quantized picture values in the last block quantized and the target data volume equal to the residual data volume divided by the number of blocks still to be quantized. When this is the case, the amount of calculation needed to carry out the method is reduced.

To ensure that all the picture values in a picture do not exceed a given data volume after the quantization, it is possible for a reserve factor to be introduced by which the target data volume is multiplied before the comparison with the actual data volume. The reserve factor will be a positive number<1 and may for example be 0.8.

A minimum value and/or a maximum value are advantageously preset for the quantization factor to allow upper and/or lower limits to be set for it. In this way it can be ensured that the quantization factor will vary within a given range within a picture.

Before the picture values in the first block are quantized, a starting value has to be preset for the quantization factor. This value is preferably so selected that with the expected picture it will correspond as well as possible to the quantization factor that the automatic adjustment will adjust to after a given number of blocks have been quantized. The size of the blocks is advantageously selected in such a way that the numbers of picture values in the blocks are each whole-number powers of two.

Another advantageous provision which may be made is for only whole-number powers of two to be permitted as values for the quantization factor. In digital engineering, division by a whole-number power of two is something which is particularly easy to achieve by shifting the decimal point in the value to be divided, which means that with quantization factors of this kind the quantization can be performed with a particularly small amount of effort and complication.

The picture values may for example be picture points in the spatial domain and may directly represent the luminance values and/or chrominance values for a given picture point in the picture.

The picture points may also be transformation coefficients for frequency domain encoding of the picture.

The quantized picture values are advantageously encoded before being stored in order to reduce the storage space required. When this is the case, the actual data volume is preferably determined after the encoding because it is the encoded values that are stored in the memory and hence the memory space they require that is of interest. The quantized picture values preferably undergo lossless encoding, for which purpose Huffman coding may be employed.

The present invention is explained in detail below by reference to the accompanying drawings and a preferred embodiment.

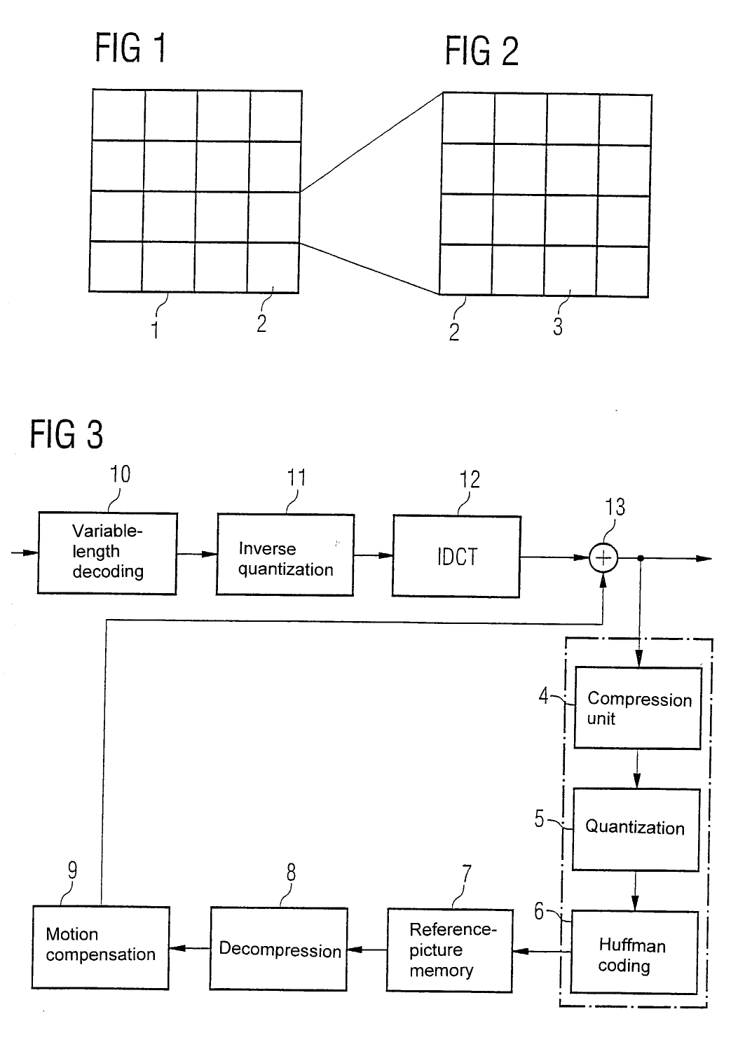

FIG. 1 shows the division of a picture to be compressed into blocks,

FIG. 2 shows a block and its associated picture values, and

FIG. 3 is a simplified block diagram of a video decoder for performing the method according to the invention.

The invention is described below by taking a video decoder employing motion-compensated prediction as an example. The decoder is a predictive hybrid coder which encodes individual pictures in the sequence of video pictures individually in the frequency domain and predicts further pictures on the basis of such pictures, which are referred to in what follows as reference pictures. A method of this kind is used in the MPEG standard for example.

In a method of this kind, it is necessary for a reference picture to be held in store for a certain period because it is needed to allow the predicted pictures to be calculated. For storage, the reference picture is quantized in this case to reduce the data volume and the size of the space required. FIGS. 1 and 2 show the makeup of a picture 1 which is to be stored as a reference picture. The picture 1 is composed of picture values 3 which are grouped together into blocks 2 which each contain the same number of picture values 3. In the present embodiment each block 2 has sixteen picture values 3.

When decoding HDTV (high-density television) signals which are to be reproduced on ordinary screens, an attempt is made, for reasons of cost, not to use a reference-picture memory able to store the individual picture dots in the HDTV format but to use simply a reference-picture memory having a reduced amount of storage space. The aim is in particular to use a reference-picture memory which is merely suitable for storing the picture data in the conventional SDTV format and which consequently has only a quarter of the storage capacity that would be required to store HDTV picture data.

The apparatus shown in FIG. 3 for decoding a TV signal has a variable-length decoder 10 to which the encoded TV signal is fed and which converts the TV information into code words of unified bit lengths. These code words are then fed to a block 11 for performing inverse quantization and then to a block 12 for performing inverse discrete cosine transformation (IDCT). To obtain the picture proper, the difference values present at the output of block 12 are added to the values for the individual picture points in a picture which is stored in a reference-picture memory 7. The reference picture stored in reference-picture memory 7 is in particular the preceding picture. The addition is carried out in an adding block 13 whose output gives the TV picture. The picture point values which are obtained in this way at the output of adder 13 are stored in reference-picture memory 7 to allow the current picture to be stored as a new reference picture. The TV decoder which is described in the embodiment is intended to receive not only conventional SDTV format signals of the normal TV resolution but also so-called HDTV (high-density television) signals and to be able to reproduce them in reduced form even on conventional screens. A crucial component of the video encoding standard is so-called motion-compensated prediction. For this, the decoder stores a preceding picture as a reference picture and it is only the differences between this and the succeeding picture which are transmitted, to allow the amount of encoding to be reduced. Also, in line with the movement in the picture, blocks, which each comprise 16×16 picture points for example, are shifted out of the preceding picture to ensure that the succeeding picture is predicted as well as possible.

Because the reference-picture memory 7 is only designed to store picture data in the conventional SDTV format, the picture data present at the output of adder 13 has to be compressed accordingly. There is a unit 4 provided for this purpose which compresses the picture area to be compressed by, for example, undersampling.

In unit 4, the block 2 to be compressed may be divided into at least a first and a second layer, with the first and second layers corresponding to different sampling patterns for the block 2 to be compressed, and a predicted picture point value may be determined for each picture point (pixel) in the second layer from picture point values for picture points in the first layer which are adjacent to the particular picture point in block 2 and the difference between the predicted picture point value and the actual picture point value for the particular picture point may be emitted for further processing by the quantizer 5.

The compressed output signal from unit 4 is conveyed to a quantizer 5 which quantizes the compressed picture data and in this way further reduces the data volume. The quantization is performed with a quantization factor, by which the output values produced by the compression in unit 4 are divided. This reduces the numerical values and as a result the data volume becomes smaller. The output signal from quantizer 5 is conveyed to a Huffman encoder 6 which encodes the data by run-length encoding of the zeroes before it is stored in reference-picture memory 7.

The quantization factor is a whole-number power of two to simplify the division by it. The quantization factor also has an upper limit of 256 set for it and a lower limit of 32.

In quantizer 5, the output data from unit 4 is quantized block by block by the quantization factor. After each block 2 is quantized, the quantization factor is adjusted, the purpose of this being to allow the storage space in reference-picture memory 7 to be utilised to the best possible effect. After the values in a block 2 have been quantized and these quantized values have been encoded in encoder 6, an actual data volume is determined which is the data volume represented by the output values from encoder 6 for a block 2. After this a target data volume is determined which is equal to the storage space still available in reference-picture memory 7 divided by the number of blocks still to be quantized. The target data volume is the volume of storage space which could be allocated to any quantized, encoded block 2 if all the blocks 2 were to be given at least substantially the same amount of storage space after quantization and encoding.

The target data volume is then multiplied by a reserve factor of 0.8 to anticipate any unexpected demand for storage space for picture values 3. The actual data volume and the target data volume are then compared with one another. If the actual data volume is larger than the target data volume, the quantization factor is raised by one step to produce a higher dividing factor and hence a smaller data volume for the next block. Otherwise the quantization factor is lowered, as a result of which the dividing factor obtained in the next block is lower.

The actual data volume is determined in this case by reference to the encoded data because this is what is in fact stored in reference-picture memory 7. To allow the subsequent pictures to be predicted by reference to the reference picture, the picture data stored in reference-picture memory 7 is conveyed to a decompression block 8, where picture data in the original picture format, such as the HDTV format, is obtained, and is fed to a motion-compensating unit 9. Present at the end of the motion-compensating unit 9 is the complete picture data, which is conveyed to adder 13.

The method according to the invention is used in the embodiment described for the compressed storage of a reference picture in a predictive TV decoder because there is only a given volume of storage space available for the reference picture to be stored in and this has to be used to the best possible advantage. However, as well as this it is also possible for the method according to the invention to be used to compress individual pictures in for example digital cameras. It may in addition be used wherever an individual picture needs to be quickly compressed to a given preset amount of data.

If the picture values exist as transformation coefficients for a transformation in the frequency domain, such as discrete cosine transformation coefficients for example, there is an advantageous improvement in picture quality. This is attributable to the fact that transformation in the frequency domain means that homogeneous regions of a picture produce small numbers of coefficients different from zero and in non-homogeneous regions large numbers of coefficients different from zero. What has to be remembered in this case is that excessive quantization, i.e. a reduction in the range of values for the picture values and hence a coarser gradation of the picture values, is more noticeable in homogeneous regions of a picture than in non-homogeneous ones, in which there are marked fluctuations anyway. Because, in the method according to the invention, the quantization factor is adjusted in such a way that the data volume represented by the quantized picture values remains approximately constant, a lower quantization factor will be set to in homogeneous regions of a picture where there are only small numbers of coefficients different from zero and the coefficients will thus be stored at high resolution. The result of this will be that the transformation coefficients for regions of a picture containing homogeneous blocks are stored at a higher resolution than those for regions of a picture containing non-homogeneous blocks and the homogeneous blocks, in which quantizing errors are more noticeable, are stored with a better quality.

1. Method of compressing a picture (1) existing in the form of discrete picture values (3), the picture values (3) being divided into blocks (2) and being quantized block by block by a quantization factor, with the data volume represented by quantized picture values (3) dropping as the quantization factor rises,
characterised in that
after the picture values (3) in a block (2) have been quantized, an actual data volume is determined which corresponds to that data volume represented by the quantized picture values (3) in the last block quantized (2) which is related to the number of picture values (3) in said last block quantized (2), and
a target data volume is determined which corresponds to that residual data volume which is available for the picture values (3) in the picture (1) that have still to be quantized and which is related to the number of picture values (3) in the picture (1) that have still to be quantized, and
the quantization factor is raised if the actual data volume is larger than the target data volume and the quantization factor is lowered if the actual data volume is smaller than the target data volume.

2. Method according to claim 1,
characterised in that
all the blocks (2) have the same number of picture values (3) and the actual data volume corresponds to the data volume represented by the quantized picture values (3) in the last block quantized (2) and the target data volume corresponds to the residual data volume related to the number of blocks (2) still to be quantized.

3. Method according to claim 1,
characterised in that
before the comparison with the actual data volume, the target data volume is multiplied by a positive reserve factor which is<1.

4. Method according to claim 3,
characterised in that
the reserve factor is<0.8.

5. Method according to claim 1,
characterised in that
the quantization factor is limited by a maximum value in the upward direction.

6. Method according to claim 1,
characterised in that
the quantization factor is limited by a minimum value in the downward direction.

7. Method according to claim 1,
characterised in that
only whole-number powers of two are permitted as values for the quantization factor.

8. Method according to claim 1,
characterised in that
the numbers of picture values (3) in the blocks (2) in the picture (1) are always whole-number powers of two.

9. Method according to claim 1,
characterised in that
before the quantization of the picture values (3) in the first block (2), the quantization factor is set to a starting value.

10. Method according to claim 1,
characterised in that
the picture (1) is a reference picture for use by a method of picture sequence encoding or picture sequence decoding employing temporal prediction.

11. Method according to claim 1,
characterised in that
the picture (1) is the reference picture for use in a method of picture sequence encoding or picture sequence decoding employing motion-compensated prediction.

12. Method according to claim 1,
characterised in that
the picture values (3) are picture points in the spatial domain.

13. Method according to claim 1,
characterised in that
the picture values (3) are transformation coefficients for frequency domain encoding of the picture (1).

14. Method according to claim 1,
characterised in that
quantized picture values (3) are lossless encoded.

15. Apparatus for compressing a picture (1) existing in the form of discrete picture values (3), the picture values (3) being divided into blocks (2) for quantization block by block by a quantization factor, with the data volume represented by quantized picture values (3) dropping as the quantization factor rises,
characterised in that
the apparatus has a picture memory (7) to store the picture values (3) in the picture (1) and a quantizer (5) to quantize the picture values (3) with a quantization factor,
the apparatus being so arranged that after the quantization of the picture values (3) in a block (2) it determines an actual data volume which corresponds to that data volume represented by the quantized picture values (3) in the last block quantized (2) which is related to the number of picture values (3) in said last block quantized (2) and it determines a target data volume which corresponds to that residual data volume which is available for the picture values (3) that have still to be quantized and which is related to the number of picture values (3) in the picture (1) that have still to be quantized, and it raises the quantization factor if the actual data volume is larger than the target data volume and lowers the quantization factor if the actual data volume is smaller than the target data volume.

16. Apparatus according to claim 15,
characterised in that
the residual data volume corresponds to the volume of storage space still left in the picture memory (7) for the storage of quantized picture values (3).

17. Apparatus according to claim 15,
characterised in that
the apparatus has an encoder (6) which encodes the quantized picture values (3) before storage in the picture memory (7).

18. Apparatus according to claim 15,
characterised in that
the apparatus is designed to carry out the method according to claim 1.
